(19) United States
(12) Patent Application Publication
(10) Pub. No.: US 2026/0047594 A1
(43) Pub. Date: Feb. 19, 2026

(54) BATTER MACHINES FOR FOOD PROCESS LINE MACHINES

(71) Applicants: Rex R. Gurnee, JR., Pierce City, MO (US); Philip Hurwitz, Springfield, MO (US); Bradly A. Nothum, Springfield, MO (US)

(72) Inventors: Rex R. Gurnee, JR., Pierce City, MO (US); Philip Hurwitz, Springfield, MO (US); Bradly A. Nothum, Springfield, MO (US)

(21) Appl. No.: 19/285,301

(22) Filed: Jul. 30, 2025

Related U.S. Application Data
(60) Provisional application No. 63/677,066, filed on Jul. 30, 2024.
(60) Provisional application No. 63/853,718, filed on Jul. 30, 2025.

(51) Int. Cl. A23P 20/17

(52) U.S. Cl. CPC A23P 20/17

(57) ABSTRACT

Improvements in batter coating machines for automatic food process lines include improvements at least in connection with (1) a variable height adjustment system for the submerging conveyor, (2) a batter mixing tank for mixing fresh batter, (3) a viscosity management system, (4) a batter pool leveling system, a (5) a dual batter pump and three-way valve system for pumping fresh batter or for recirculation, (6) a ‘waste’ conveyor for removing ‘waste’ material (albeit still food grade) from the main batter pool, (7) an auxiliary accurate feed machine of dry ingredients and wet ingredients (presumably water, but other things like milk or egg whites and so on are not excluded), and the like.

### CROSS-REFERENCE TO PROVISIONAL APPLICATION(S)

This application claims the benefit of U.S. Provisional Application No. 63/677,066, filed Jul. 30, 2024, and U.S. Provisional Application No. 63/853,718, filed Jul. 30, 2025. The foregoing patent disclosure(s) is(are) incorporated herein by this reference thereto.

### BACKGROUND AND SUMMARY OF THE INVENTION

The invention generally relates to automatic and/or mechanized food-process line equipment and, more particularly, to improvements in batter machines for food process line machines.

An exemplary batter machine for automatic and/or mechanized food-process lines include without limitation the following patent disclosure, which is incorporated herein for all purposes by this reference thereto.

U.S. Pat. No. 6,510,810—Nothum, Sr. et al., entitled “Convertible Combination Batter Mixer And Applicator Machine.”

Briefly, the basics of such a food process line and batter machine therefor are as follows. A series of machines are arranged in a conveyor line, to process food product pieces with one or more coatings before being par-fried. Such food product pieces include without limitation chicken (eg., tenders), fish (eg., fillets or sticks), beef or pork (eg., patties or whole pieces), meatballs, cheese (eg., sticks), vegetables, and on an on.

The food product pieces are loaded at some original station onto a conveyor, typically a stainless steel wire mesh conveyor. The food product pieces are then ushered through perhaps a series of coating machines, including a pre-dust machine, a batter coating machine (eg., a wet coating), a breading machine (eg., another dry coating), a hot oil fryer to set the coatings, and then packaging and freezing.

So turn to the batter coating machine, it can be characterized as having:
an elongated vat filled (to a given fill level) with a pool of batter,
a main food-product carrying conveyor plunging through and then out of the pool of batter in a shallow-V shaped path, and
an overhead submerging conveyor pushing down on the food-product pieces so that the food-product pieces not only are immersed in the pool of batter and thereby coated but also do not float and lose conveyance traction with main conveyor.

The extends between an intake end and discharge end. The intake end receives food-product pieces from an upline process (eg., transfer conveyor or, for example and without limitation, a pre-dusting machine with a dry spice mix). The discharge end discharges food-product pieces to a downline process (eg., another transfer conveyor or, for example and without limitation, a breading machine or Panko machine or a hot oil fryer or whatever).

The disclosure herein uses reference terms for direction as RIGHT side of the batter machine and LEFT side of the batter machine (in contrast to left side of a figure drawing or right side of a figure drawing). The RIGHT side and LEFT side of the batter machine is determined by an observer who is standing behind the very beginning of the food process line (which typically begins with a food-product loading station) and looking down the line to the termination (which is typically a hot oil fryer). Given that observer's vantage point, then the RIGHT side of the batter machine and LEFT side thereof are that observer's “right” and “left.”

A number of additional features and objects will be apparent in connection with the following discussion of the preferred embodiments and examples with reference to the drawings.

### BRIEF DESCRIPTION OF THE DRAWINGS

There are shown in the drawings certain exemplary embodiments of the invention as presently preferred. It should be understood that the invention is not limited to the embodiments disclosed as examples, and is capable of variation within the scope of the skills of a person having ordinary skill in the art to which the invention pertains. In the drawings,

FIG. 1 is a perspective view of the RIGHT side of a batter machine in accordance with the invention for automatic and/or mechanized food-process lines, wherein the sidewall cover panels are removed from view to better show various inner workings of the batter machine;

FIG. 1 furthermore shows portions of a viscosity management system, a fresh batter pump, and a recirculating batter pump for returning excess buildup of batter at the main food-product conveyor's discharge end back to the intake end thereby to level the batter pool (intake end is to the left in the view, discharge end to the right in the view);

FIG. 2 is a side elevation view of the LEFT side of the batter machine, showing the LEFT side (again, the machine's LEFT side) forward and rearward inverted L-shaped cranks of the cam system that drives the four legs of the submerging conveyor between HIGH and LOW elevational extremes, thus the LEFT side forward and rearward inverted L-shaped cranks and legs are seen in this view, and the RIGHT side counterpart forward and rearward inverted L-shaped cranks and legs can be seen in FIG. 1;

FIG. 3 is an enlarged-scale close up view of the LEFT side rearward inverted-L shaped crank and LEFT side rearward vertically/axially straight leg, with the RIGHT side rearward inverted-L shaped crank being only partially in view in the background by being obstructed in the view by the nearer LEFT side rearward inverted-L shaped crank in the foreground, which two cranks are connected by a common drive axle;

FIG. 4 is an enlarged-scale close up view of the RIGHT side rearward inverted-L shaped crank and RIGHT side rearward vertically/axially straight leg in the foreground, with the LEFT side rearward inverted-L shaped crank being only partially in view in the background, and again which two cranks are connected by that common drive axle;

FIG. 5 is a perspective view of a dual-lobed vertical mixing tank in accordance with the invention, and a chute formed in a portion of the hood for the batter machine, the chute for supplying batter mix ingredients (the dry mix ingredients and water) into the dual-lobed vertical mixing tank;

FIG. 6 is an overhead perspective view looking through the chute into the dual-lobed vertical mixing tank, wherein a mixing rotor is partly in view, wherein also in view at the top left of the view is the upper food-product carrying run of the main food-product conveying conveyor, and at the top right of the view is the upper return run of the submerging conveyor and the submerging conveyor's passive rearward nose roller where the submerging changes angular direction by about ˜180° and thus begins as the lower food-product submerging run of the submerging conveyor;

FIG. 7 is perspective view of the rearward (upline) end of the batter machine showing the intake end of the main food product conveying conveyor, and showing the dual-lobed mixing tank tilted, as for access for cleaning or maintenance and so on;

FIG. 7 also shows dual rotors inside the dual-lobed mixing tank;

FIG. 8 is a perspective view better showing at least one embodiment of a rotor in accordance with the invention, wherein the rotor has a bottom set of four (4) vanes spaced 90° apart from one another and a vertically spaced upper set of four (4) relatively diminished-sized vanes also spaced 90° apart from one another but offset 45° from the bottom set;

FIG. 9 is an enlarged perspective view the embodiment of the rotor shown in FIG. 8 shown here in isolation, which configuration here is preferred for regular (or typical) batters;

FIG. 10 is an enlarged perspective view of an alternate embodiment of a mixing rotor in accordance with the invention, showing a configuration something like a Japanese box-kite shaped rotor, which might be preferred for tempura batters or the like;

FIG. 11 is a perspective view showing the inboard side, and discharge end, of an auxiliary machine comprising an accurate feed machine of dry mixture and water, wherein this auxiliary machine stands to the RIGHT side of the batter machine (again, the batter machine's RIGHT side) and discharges into the chute shown better in FIGS. 5 and 6;

FIG. 12 is a side perspective view of the auxiliary, accurate feed machine; wherein the batter machine would be to the left in the view (but is not in view at all in this FIG. 12), and shows (to the right in the view) an infeed opening for pouring in of dry batter mix, which infeed opening is protected by a grate;

FIG. 13 is an overhead, rearward-looking perspective view for an observer standing on the batter machine's RIGHT side and adjacent the discharge end of the main food-product conveying conveyor (discharge end not in view, but see FIGS. 14 and 15), wherein this FIG. 13 also shows the forward passive nose roller of the submerging conveyor which is where the lower submerging run comes up and rotates ˜180° counterclockwise in the view and becomes the upper return run of the submerging conveyor, and wherein the center of the upper return run is occupied by a drum drive roller (ie., it is a motor that has the skin or outer sidewall of the motor rotating around a fixed central axle/shaft) and is disposed at a high elevation above the given fill level of the batter pool in the vat (or bathtub) that contains the batter pool;

FIG. 14 is rearward-looking perspective view of the discharge end of the batter machine, wherein the discharge end of the main food-product conveying conveyor rolls ˜180° around its drum drive roller and hence is driven thereby (not in view here but indicated in sketch lines in FIG. 17), and wherein a transverse waste conveyor is shown floating in isolation below the batter machine in order to better show its transverse extent;

FIG. 15 is rearward-looking perspective view comparable to FIG. 14, except on a slightly-reduced scale and showing the waste conveyor installed in an operable position, whereby whatever material sinks in the pool of batter below the discharge end of the main food-product conveying conveyor is regarded as ‘waste’ and is ejected out of the batter pool by the waste conveyor;

FIG. 16 is a perspective view of the RIGHT side of the machine, being a close-up of some matters previously shown in FIG. 1, but now here showing portions of a dual pump and drive motors for not only a fresh-batter supply system but also a viscosity management system that includes a viscosity measuring sensor as well as a controller for raising or lowering the viscosity of the batter (thicker or thinner) in the batter pool to some pre-selected target value (eg., add more dry mix or add more water); and

FIG. 17 is a schematic of a batter-pool leveling system in accordance with the invention.

### DETAILED DESCRIPTION OF THE PREFERRED EMBODIMENTS

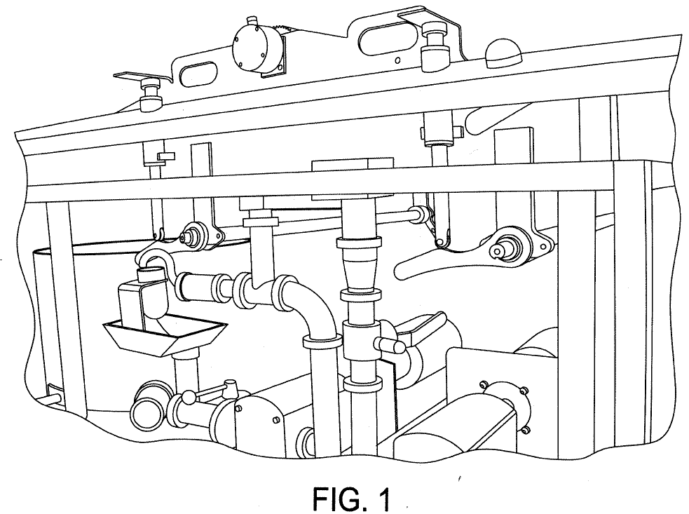

FIG. 1 shows the RIGHT side of the batter machine in accordance with the invention for automatic and/or mechanized food-process lines. Normally this would be covered with sidewall cover panels, but those are removed from view to better show various inner workings of the batter machine. FIG. 1 furthermore shows portions of a viscosity management system, a fresh batter pump, and a recirculating batter pump for returning excess buildup of batter at the main food-product conveyor's discharge end back to the intake end thereby to level the batter pool (intake end is to the left in the view, discharge end to the right in the view).

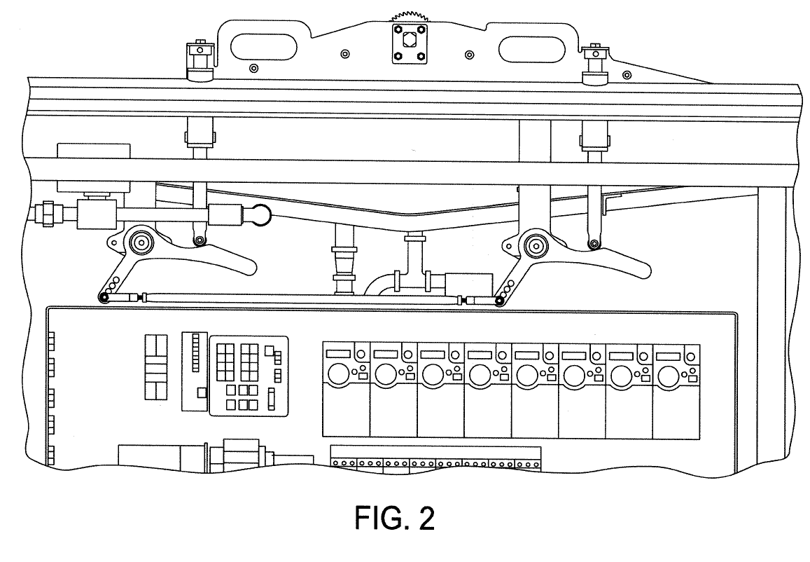

FIG. 2 switches around and now shows the LEFT side of the batter machine, showing the LEFT side (again, the machine's LEFT side) forward and rearward inverted L-shaped cranks of the cam system that drives the four legs of the submerging conveyor between HIGH and LOW elevational extremes. Thus the LEFT side forward and rearward inverted L-shaped cranks and legs are seen in this view, and the RIGHT side counterpart forward and rearward inverted L-shaped cranks and legs can be seen in FIG. 1.

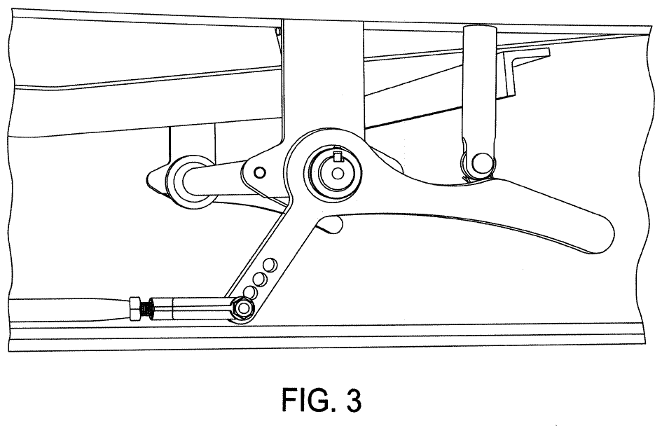

FIG. 3 is a close up of the LEFT side rearward inverted-L shaped crank and LEFT side rearward vertically/axially straight leg. The RIGHT side rearward inverted-L shaped crank is only partially in view in the background for reason of being obstructed in the view by the nearer LEFT side rearward inverted-L shaped crank in the foreground. The LEFT side rearward inverted-L shaped crank and the RIGHT side rearward inverted-L shaped crank are connected by a common drive axle.

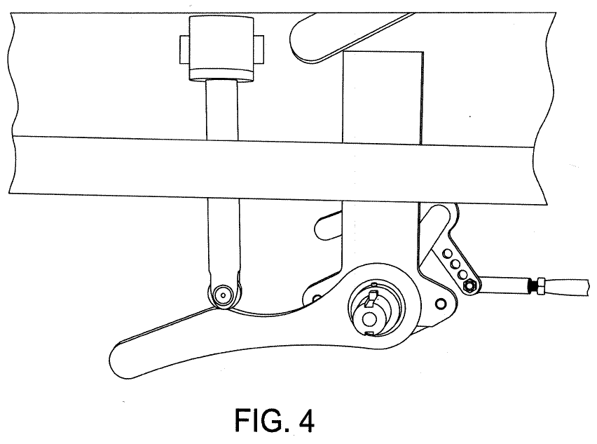

FIG. 4 is a close up of the RIGHT side rearward inverted-L shaped crank and RIGHT side rearward vertically/axially straight leg in the foreground. The LEFT side rearward inverted-L shaped crank is only partially in view in the background. And again, the two cranks are connected by that common drive axle.

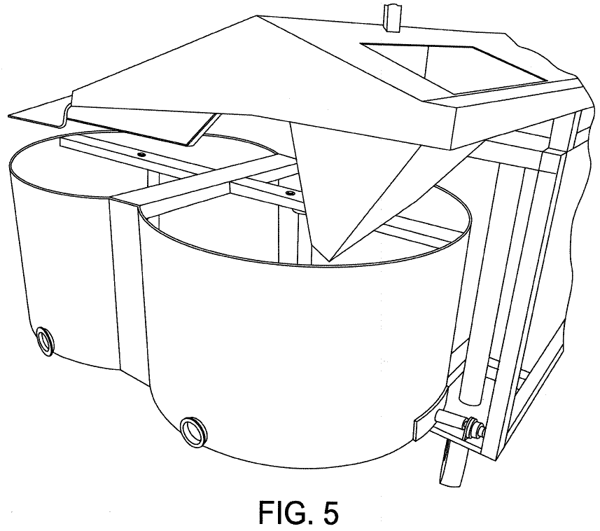

FIG. 5 shows a dual-lobed vertical mixing tank in accordance with the invention, and a chute formed in a portion of the hood for the batter machine, the chute for supplying batter mix ingredients (the dry mix ingredients and water) into the dual-lobed vertical mixing tank.

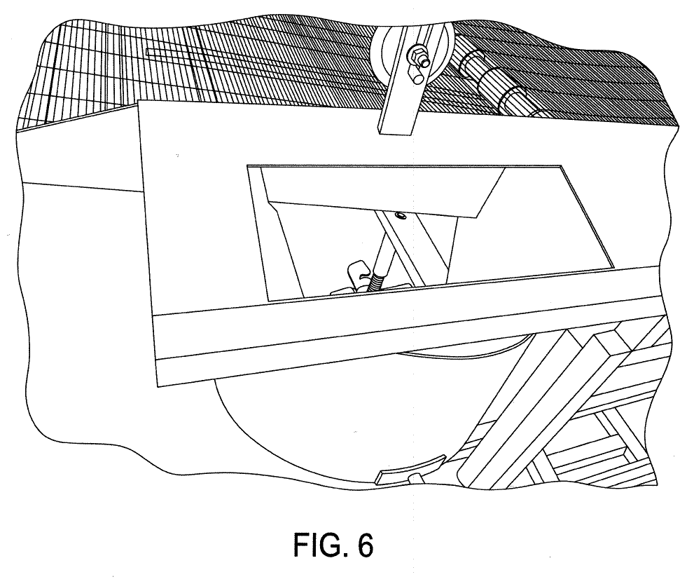

FIG. 6 is a view looking through the chute into the dual-lobed vertical mixing tank. A mixing rotor in accordance with the invention is partly in view. Wherein also in this view (at the top left of the view) is the upper food-product carrying run of the main food-product conveying conveyor. And at the top right of the view is the upper return run of the submerging conveyor and the submerging conveyor's passive rearward nose roller. The passive rearward nose roller is where the submerging conveyor rotates around (changes angular direction by about) ˜180° and thus transitions into becoming the lower run (the food-product submerging run) of the submerging conveyor.

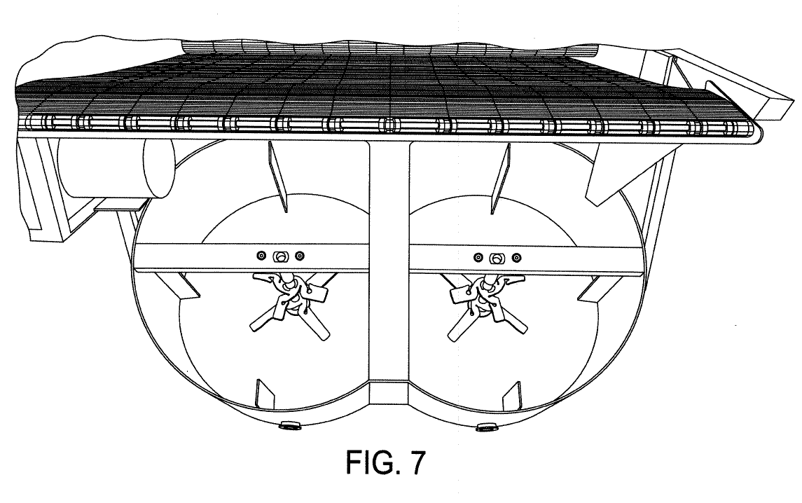

FIG. 7 shows the rearward (upline) end of the batter machine showing the intake end of the main food product conveying conveyor. The dual-lobed mixing tank is tilted, as for access for cleaning or maintenance and so on. FIG. 7 also shows dual rotors inside the dual-lobed mixing tank.

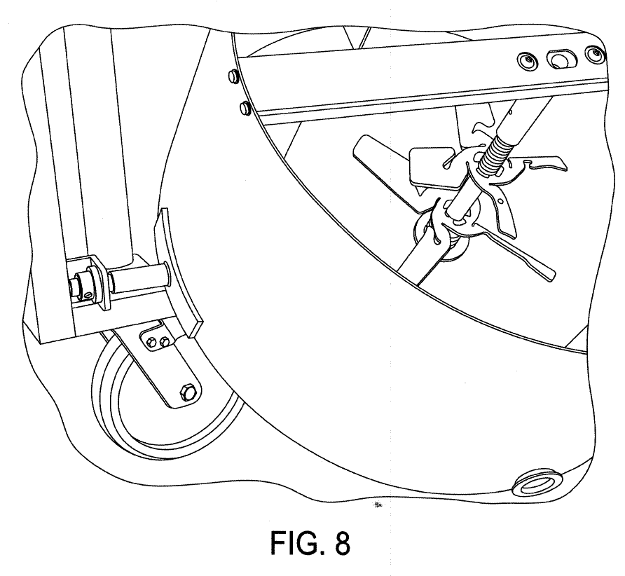

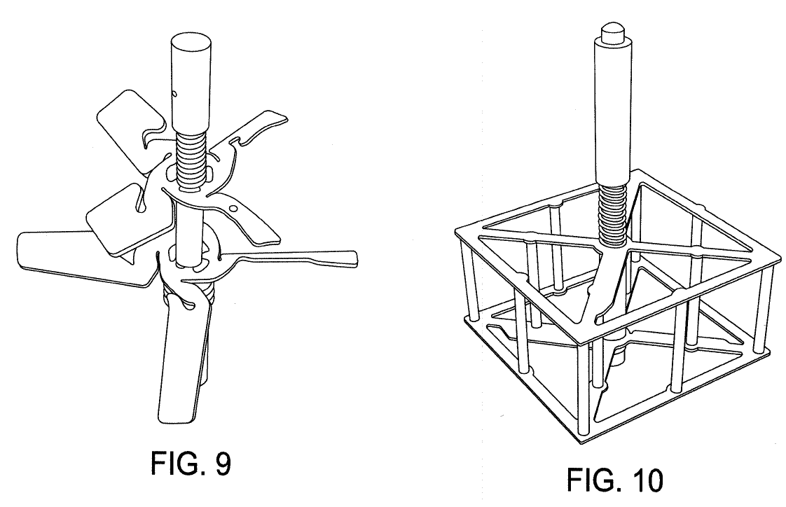

FIGS. 8 and 9 show at least one embodiment of a rotor in accordance with the invention, wherein the rotor has a bottom set of four (4) vanes spaced 90° apart from one another and a vertically spaced upper set of four (4) relatively diminished-sized vanes also spaced 90° apart from one another but offset 45° from the bottom set. This configuration is preferred for regular (or typical) batters.

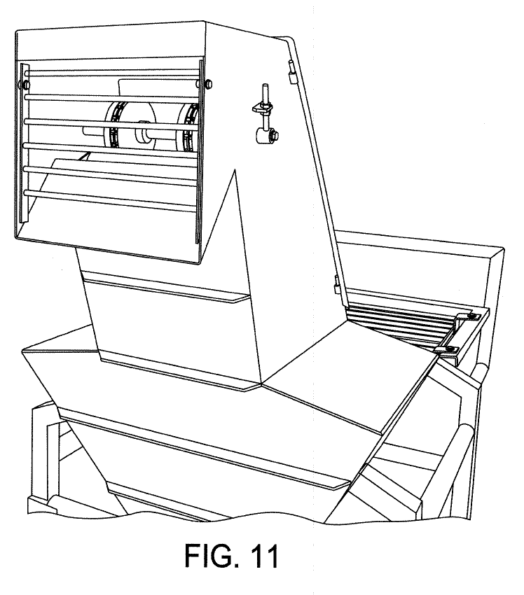

FIG. 10 show an alternate embodiment of a mixing rotor in accordance with the invention. This time, this rotor is configured something like a Japanese box-kite shaped rotor, and would be preferred for tempura batters or the like.

FIG. 11 shows the inboard side (and discharge end) of an auxiliary machine comprising an accurate feed machine of dry mixture and water. This auxiliary machine stands to the RIGHT side of the batter machine (again, the batter machine's RIGHT side) and discharges into the chute shown better in FIGS. 5 and 6.

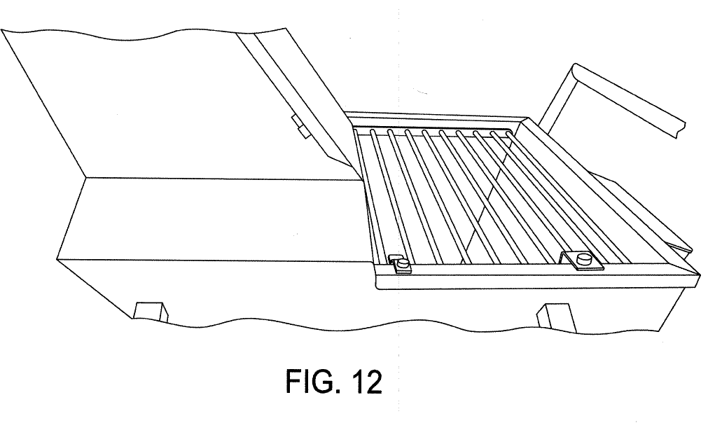

FIG. 12 shows the side (upline side) of the auxiliary, accurate feed machine. The batter machine, if shown, would be to the left in the view, but is not shown here. FIG. 12 also shows (to the right in the view) an infeed opening for pouring in of dry batter mix, which infeed opening is protected by a grate.

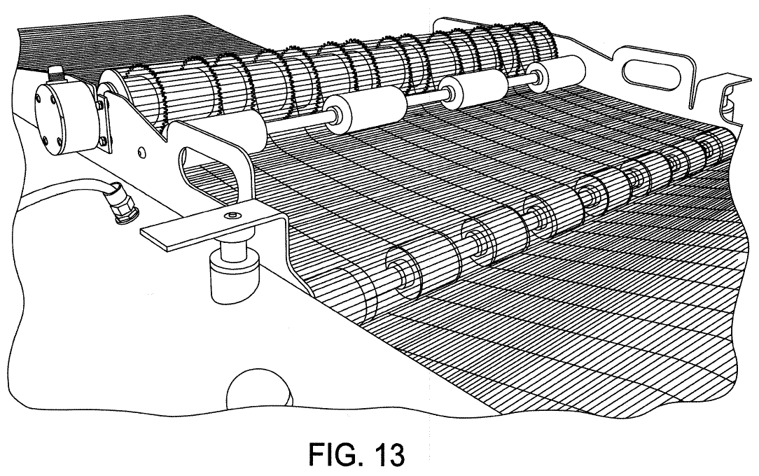

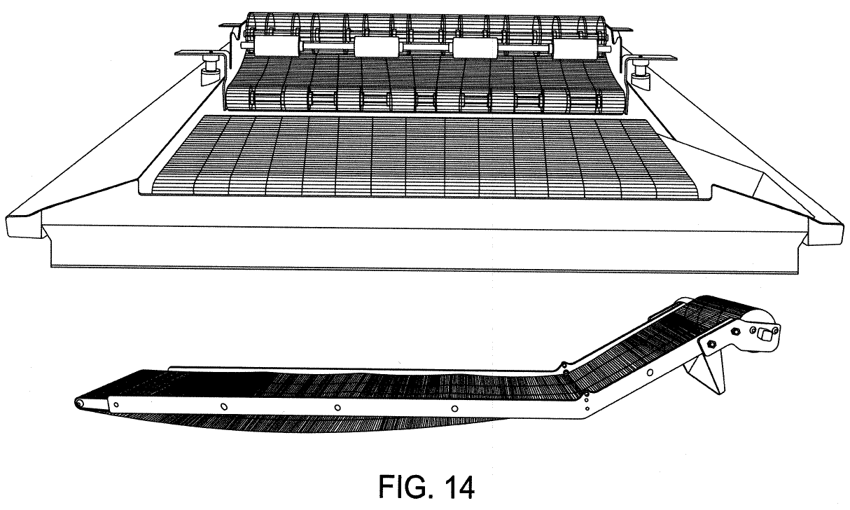

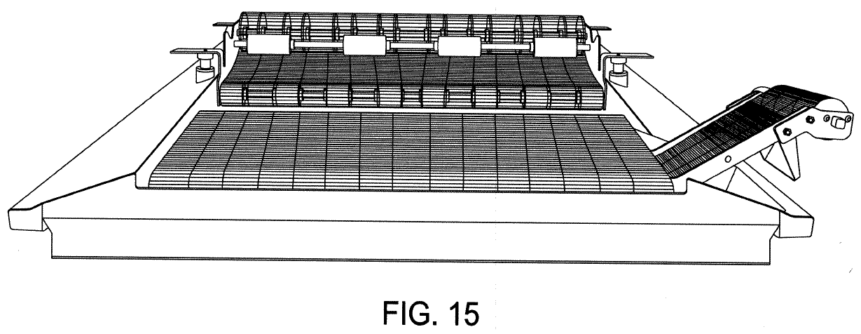

FIG. 13 is an overhead, rearward-looking view for an observer standing on the batter machine's RIGHT side and adjacent the discharge end of the main food-product conveying conveyor (discharge end not in view, but see FIGS. 14 and 15). FIG. 13 also shows the forward passive nose roller of the submerging conveyor which is where the lower submerging run comes up and rotates ˜180° counterclockwise in the view and thus transitions into becoming the upper return run of the submerging conveyor. Disposed at the center of the upper return run is a drum drive roller. Drum rollers are drum motors that has the skin or outer sidewall off the motor rotating around a fixed central axle/shaft. In other words, this is opposite of the pump motors, which have stationary outer sidewalls and rotating central shafts. The drum drive roller is disposed at a high elevation above the given fill level of the batter pool in the vat (or bathtub) that contains the batter pool.

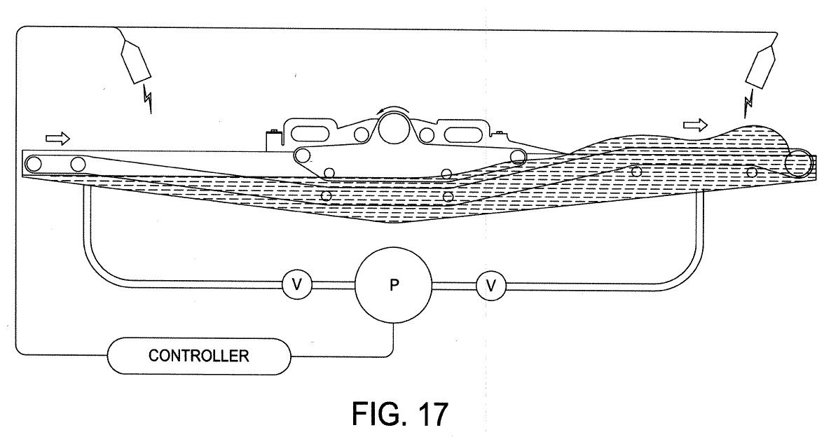

FIG. 14 is rearward-looking perspective view of the discharge end of the batter machine. The discharge end of the main food-product conveying conveyor rolls ˜180° around its drum drive roller and hence is driven thereby. The main food-product conveying conveyor drum drive roller is not in view here but is indicated in sketch lines in FIG. 17. There is also shown a transverse waste conveyor depicted as floating in isolation below the batter machine in order to better show the transverse waste conveyor's transverse extent.

FIG. 15 is rearward-looking perspective view comparable to FIG. 14, except on a slightly-reduced scale and showing the waste conveyor installed in an operable position. Thus, whatever material sinks in the pool of batter below the discharge end of the main food-product conveying conveyor is regarded as ‘waste,’ and, is ejected out of the batter pool by the waste conveyor.

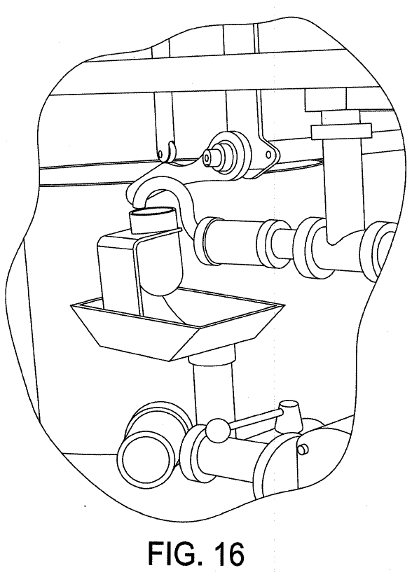

FIG. 16 shows the RIGHT side of the machine (with cabinet sidewall panels removed), and shows some matters previously shown in FIG. 1. That is, FIG. 16 shows portions of the dual pump and drive motors for not only a fresh-batter supply system but also a recirculation system and a viscosity management system that includes a viscosity measuring sensor as well as a controller for raising or lowering the viscosity of the batter (thicker or thinner) in the batter pool to some pre-selected target value (eg., add more dry mix or add more water).

FIG. 17 is a schematic of a batter-pool leveling system in accordance with the invention.

### I.

So some highlights of the foregoing or additional aspects of the batter machine in accordance with the invention include without limitation the following.

There is a four-legged cam lifting system for the food-product submerging belt. The four-legged cam system raises and lowers the submerging conveyor for taller or shorter food product pieces, respectively. The four-legged cam system furthermore has an extreme upward height for cleaning and maintenance operations. The vat (bathtub) containing the batter pool has a glycol cooling jacket.

The rotors for mixing the mix of dry mix and water are quickly disconnected and re-connected to their vertical drive spindles. The rotors can take different shapes. For example, a square Japanese-kite form is preferred for tempura, whereas other rotor shapes are preferred for more regular types of batter.

The types of food pieces coated by the batter hereof include:

chicken nuggets,

chicken tenders,

bone-in chicken pieces and so on.

A scaled accurate-feed auxiliary machine accurately measures the ratios of dry mix to water to feed the dual-lobed mixing tank. There is a very precise target of water to dry mix ratio.

It is an aspect of the invention to motivate (pump) the build-up of batter at the discharge end back to the center of the machine (eg., center of the batter-containing well centered with the submerging conveyor). The thicker the batter (like peanut butter), the more likely it is to get dragged toward and build-up at the product-discharging end of the main food-product conveyor. It is an aspect of the invention to return that excess build-up of batter back. See FIG. 13. An added pump returns the thicker batter to the center or intake end of the batter machine batter pool where conveying pieces of food product are submerged by the submerging conveyor.

In FIG. 13, there are a pair of batter-pool height sensors (batter-pool elevation sensors) which use radar technology. One sensor is closer to (or covering the batter-pool height of) the food-product pieces infeed end of the main conveyor. The other sensor closer to (or covering the batter-pool height of) the food-product pieces discharge end of the main conveyor. When the pool is higher or lower in one of the covered regions of the sensors, the automatic control system pumps the high spot to the low spot to even (level) the batter-pool surface again.

Typically, the discharge end will be more often be the high end. The combined signals of the height sensors also control the accurate-feed mixing system to bring batter pool level up to FULL target fill-level status. When radar sensors provide a reading corresponding to FULL, the accurate-feed system shuts off the feed of fresh batter to the vat (bathtub). And again, any batter that gets piled up at one end or the other (but typically at the discharge end, and pumped back to the center of the vat or other end.

There is a viscosity check system for the batter mixture, which includes auto-actuators and housings for their valves.

The dual-lobed mixing tank has a pair of vertical mixer shafts. FIGS. 7 and 8 show a pair counter-rotating four-winged (four-vaned) impeller-style mixing rotors welded to shaft. There are larger set of mixing vanes on the bottom and smaller set halfway up the shaft. There is a square drive on bottom of shafts.

The mixing tank is dual-lobed. That is, the mixing tank is like two circular tanks merged with each other to create “dog-bone” style look. The dual-lobed mixing tank is disposed externally of batter pool vat (the main processing, batter-coating container). The dual-lobed mixing tank has multiple connection points for adding fresh batter to main batter pool and/or the viscosity management system (add water, add dry mix, pump and so on). For example, there are two drains on front for drainage. The mixing tank is provided with a split lid held down by toggle clamps. The mixing shafts are turned by motor via pulleys and timing belts. There is a guard on bottom to cover bearings/pulleys/timing belts. There is a handle for tilt function.

In FIGS. 7 and 8, the mixing tank is shown tilted for clean out and inspection. The mixing tank is titled (rotated) via stub shafts welded to tank that sit on respective UHMW bushings and supported by gas springs for ease of operation. There is a spring plunger to lock the mixing tank in place in multiple angled positions.

FIG. 1 shows a two pump system. The first pump pulls batter from mixing tank and directs it either to main processing vat or to check viscosity, which under certain circumstance directs the batter back into mixing tank for viscosity adjustment. The second pump pulls batter from the main processing vat and either directs back to the main processing vat albeit elsewhere from the batter was pulled, or to check viscosity and perhaps back into mixing tank for viscosity adjustment. Flexible tubing and valves are used generously for ease of operation and drainage. Three-way valves are used for re-directing the direction of batter flow. The pumps are mounted on sliding mounts for serviceability. Cam lock quick disconnects connected to mix tank for ease of operation. Valves are actuated by pneumatic actuators to control direction of flow.

### II.

Whether redundant to the above or not, highlights of the foregoing or additional aspects of the batter machine in accordance with the invention include without limitation the following.

There is a variable height adjustment of submerging conveyor by four legs riding on respective rollers that roll on respective cam surfaces of four inverted-L shaped rocking arms. There are an opposite rearward pair of LEFT and RIGHT inverted-L shaped rocking arms interconnected by a rearward common axle. And there are an opposite forward pair of LEFT and RIGHT inverted-L shaped rocking arms interconnected by a forward common axle. The LEFT side rearward and forward inverted-L shaped rocking arms are interconnected by a straight drive rod. Thus providing a drive input to any one (1) of the four (4) inverted-L shaped rocking arms in turn drives all four (4) inverted-L shaped rocking arms in unison. The fully open state (maximum height) for the submerging conveyor is for cleaning purposes. Otherwise the relative height (state) of the submerging conveyor relative to the upper run of the main conveyor is adjustable by fine adjustment for defining the overhead gap above the upper run of the main food-product-carrying conveyor. This accommodates different size food-product pieces.

Another aspect of the invention concerns batter pool leveling control. The problem is that, thicker batters are like peanut butter, but even thinner batters are viscous. The batter pool ‘level’ is not level from intake end to discharge end. The main processing vat (batter pool container) might have dimensions very approximately six feet in length and forty-two inches wide. As FIG. 13 shows, without intervention the discharge end would tend to be in a perpetual state of ‘high tide’ while the intake end, ‘low tide.’

To overcome this, there are provided a pair of batter-pool height sensors (or elevation sensors). The preferred sensors detect by means of radar technology. One sensor is aimed at the pool surface near the intake end. The other sensor is aimed at pool level surface near discharge end. The sensors send their detection information onward a controller (or the controller polls the sensors for their detection information). The controller determines the difference and sends control signals to a pump to pump batter from the high end to either the center of the vat or the low end. By such intervention, the batter pool level can be maintained relatively ‘level.’

A further aspect of the invention concerns a dual-lobed vertical mixing tank. It tilts for access, as for cleaning or swapping one configuration of rotors for another. The rotors counter-rotate. And there are a multiplicity of rotor configurations, as for regular batters to tempura batters and so on. The rotors have quick-release connections to their respective drive spindles for reasonably fast swap out.

Still other aspects of the invention concern without limitation the auxiliary accurate feed machine of dry ingredients and wet ingredients (presumably water, but other things like milk or egg whites and so on are not excluded), or otherwise, the transverse ‘waste’ removal conveyor belt. The ‘waste’ is generally food-safe materials but is nevertheless alleged to cause ‘off flavors.’ So the ‘waste’ material is removed, collected, and fed to livestock.

The invention having been disclosed in connection with the foregoing variations and examples, additional variations will now be apparent to persons skilled in the art. The invention is not intended to be limited to the variations specifically mentioned, and accordingly reference should be made to the appended claims rather than the foregoing discussion of preferred examples, to assess the scope of the invention in which exclusive rights are claimed.

What is claimed is:

1. A batter coating machine for automatic and/or mechanized food-process lines that receives an infeed of food-product pieces received at an intake end and discharges coated food-product pieces at a discharge end, comprising:
an elongated vat adapted to contain and be filled, to a given fill level, with a pool of batter;
a main food-product carrying conveyor adapted to plunge through and out of the pool of batter in a shallow-V shaped path;
an overhead submerging conveyor adapted to push down on the food-product pieces so that the food-product pieces not only are immersed in the pool of batter and thereby get coated but also do not float and lose conveyance traction with main conveyor; and
a batter pool leveling system comprising:
a batter-surface height sensor aimed at the discharge end of the batter pool adapted to provide an information signal corresponding to sensed height,
a controller receiving or polling for the sensor's information signal and adapted with a control configuration whereby determining whether intervention action is warranted or not, and
when intervention action is determined to be warranted, then sending a control signal to a pump that is connected by piping (1) to a port proximate the discharge end of the vat and (2) to a port proximate the center or intake end of the batter pool, whereby the pump executes the intervention action.
